(19) United States
(12) Patent Application Publication
(10) Pub. No.: US 2015/0145355 A1
(43) Pub. Date: May 28, 2015

(54) ENCLOSURE FOR USE OF PRIME MOVER IN A HAZARDOUS ENVIRONMENT

(71) Applicant: PHILLIPS MACHINE SERVICE, INC., Beckley, WV (US)

(72) Inventors: Jesse Kincaid, Meadow Bridge, WV (US); John Siggelkow, Bluefield, WV (US)

(21) Appl. No.: 14/401,687

(22) PCT Filed: May 16, 2013
(86) PCT No.: PCT/US2013/041346

§ 371 Date: Nov. 17, 2014

Related U.S. Application Data
(60) Provisional application No. 61/647,592, filed on May 16, 2012.

(51) Int. Cl. H02K 5/136; B65D 85/68; F01P 3/12; H02K 9/19; F02B 77/08

(52) U.S. Cl. CPC H02K 5/136; H02K 9/19; F02B 77/08; F01P 3/12; B65D 85/68
USPC 310/54; 310/88; 123/198 D; 123/41.44; 60/299; 206/319

(57) ABSTRACT

A prime mover assembly is suitable for use in a hazardous environment. The prime mover assembly includes a hazardous rated enclosure, a non-hazardous rated prime mover disposed in the enclosure, and a gland assembly extending through the enclosure in communication with the prime mover. The gland assembly provides power and instrumentation through the enclosure to the prime mover.

This application claims the benefit of U.S. Provisional Patent Application Ser. No. 61/647,592, filed May 16, 2012, the entire content of which is herein incorporated by reference.

### BACKGROUND OF THE INVENTION

The invention relates to the use of prime movers in a hazardous environment and, more particularly, to a prime mover assembly that is suitable for use in a hazardous environment.

The use of prime movers (e.g., diesel engines or electric motors) in a hazardous environment such as underground mining is closely regulated for safety concerns including, for example, engine emissions, explosions, etc. The use of diesel powered equipment in underground mining has grown steadily since the 1960's. Regulations address potential concerns with regard to health effects related to operating diesel engines in underground environments. Hazardous rated prime movers are consequently considerably more expensive than non-hazardous rated counterparts.

In order to be usable in a hazardous environment, all electrical components (engine control modules/engine control units, fuel injectors, sensors, etc.) must be either explosion proof or intrinsically safe. Also, an external temperature of the engine should not exceed 302° F. Typically, to meet these limitations, manufacturers go through great measures to keep the temperatures down and often have to significaly derate the engine's output horsepower. It would be desirable to enable the use of a standard components (i.e., non-hazardous rated) in a hazardous environment.

### SUMMARY OF THE INVENTION

By placing a component such as an engine in a cooled enclosure, it is not necessary to keep the temperatures of the exhaust manifold, cylinder head, and turbo charger below 302° F. Rather, only the external temperature of the enclosure and the final exhaust have temperature limitations. Embodiments described herein relate to a prime mover assembly utilizing non-hazardous rated prime movers and other components in a hazardous rated enclosure. With this structure, the less costly non-hazardous rated prime movers can be safely used in hazardous environments.

In an exemplary embodiment, a prime mover assembly is suitable for use in a hazardous environment. The prime mover assembly includes a hazardous rated enclosure, a non-hazardous rated prime mover disposed in the enclosure, and a gland assembly extending through the enclosure in communication with the prime mover. The gland assembly provides power and instrumentation through the enclosure to the prime mover. In one arrangement, the enclosure comprises a double wall construction. The assembly may further include a coolant in a space defined by the double wall construction. The enclosure may include an opening through which an output shaft of the prime mover is positioned. The output shaft may be supported by a bearing.

In one embodiment, the prime mover may be an electric motor. In this context, the electric motor may be a liquid cooled electric motor, where the enclosure includes a double wall construction. The prime mover assembly may also include a cooling circuit that directs a coolant through the motor and through a space defined by the double wall construction. The cooling circuit may include an outboard radiator.

In another embodiment, the prime mover may be a diesel engine. In this context, the enclosure may include a double wall construction and a coolant in a space defined by the double wall construction. The assembly may further include a cooling circuit and a pump that circulates the coolant. The cooling circuit may further include an outboard radiator. The prime mover assembly may also include an exhaust circuit and a catalyst, where the exhaust circuit is configured to route engine exhaust through the catalyst before entering the enclosure. An exhaust system includes a manifold, a turbocharger, and the catalyst, where the exhaust system is insulated from the engine. A spark arrestor may also be provided in the exhaust system. An air circuit supplies air to the engine, and the air circuit draws air through an air filter, through the enclosure, through the spark arrestor and to the engine.

In another exemplary embodiment, the prime mover assembly includes a hazardous rated enclosure including a double wall construction; a non-hazardous rated prime mover including one of an electric motor and a diesel engine; a gland assembly extending through the enclosure in communication with the prime mover, where the gland assembly provides power and instrumentation through the enclosure to the prime mover; and a coolant in a space defined by the double wall construction.

### BRIEF DESCRIPTION OF THE DRAWINGS

These and other aspects and advantages will be described in detail with reference to the accompanying drawings, in which:

FIG. 1 is a perspective view of a prime mover assembly;

FIGS. 2-4 are side, plan and end views of the assembly, respectively;

FIG. 5 is a cutaway perspective view of the prime mover assembly;

FIG. 6 shows the prime mover assembly with a liquid cooled electric motor; and

FIG. 7 is a perspective view of an explosion proof capacitor box.

### DETAILED DESCRIPTION OF THE DRAWINGS

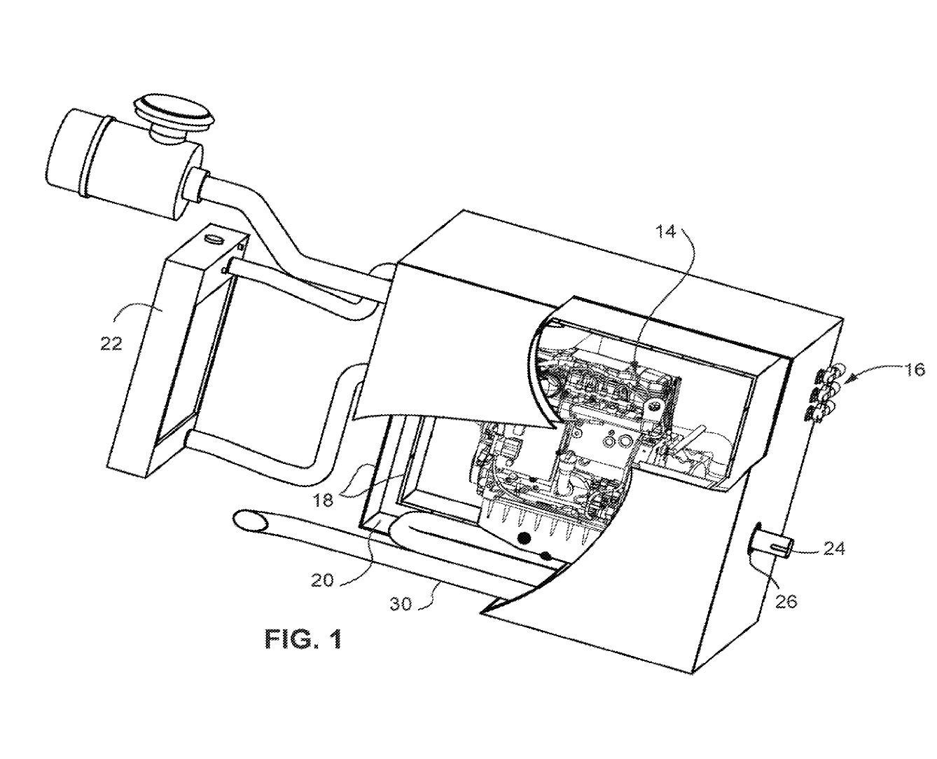

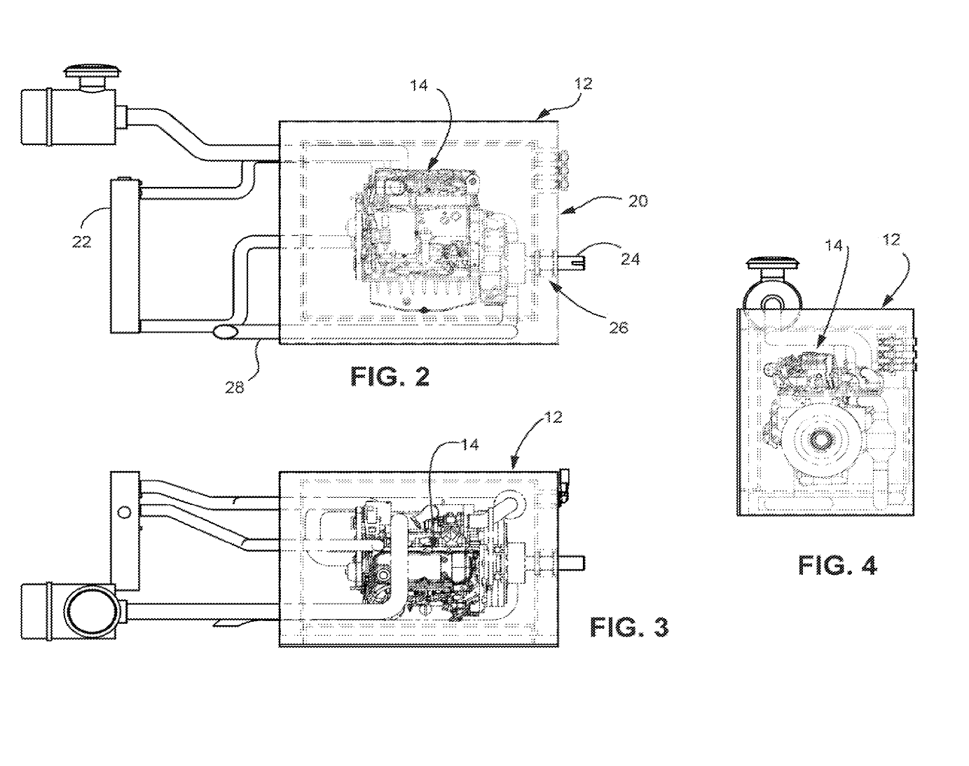

FIG. 1 is a perspective view of a prime mover assembly 10 suitable for use in a hazardous environment. FIGS. 2-4 are side, plan and end views of the assembly, respectively. The assembly includes a hazardous rated enclosure 12 that houses a non-hazardous rated prime mover 14 such as an electric motor or a diesel engine. A gland assembly 16 extends through the enclosure 12 in communication with the prime mover 14. The gland assembly 16 is preferably a standard MSHA approved gland assembly that provides power and instrumentation through the enclosure 12 to the prime mover 14.

As shown, the enclosure 12 may be provided with a double wall construction 18, which defines a coolant chamber in the space of the double wall construction. More specifically, the enclosure 12 defines a cooling circuit 20 that directs a coolant through the prime mover 14 and through the space defined by the double wall construction 18. In one embodiment, the cooling circuit further includes an outboard radiator 22.

An output shaft 24 of the prime mover 14 extends through an opening in the enclosure 12 and is preferably supported via a bearing 26 or the like. The diametric clearance between the shaft 24 and the enclosure 12 does not exceed clearance limitations specified by regulations. Additionally, the length of a flame path is greater than a minimum length specified.

In one configuration, the prime mover 14 is a standard electric motor (i.e., non-hazardous rated). Heat from the motor is transferred from the motor to the enclosure 12, through the enclosure 12 and dissipated to atmosphere.

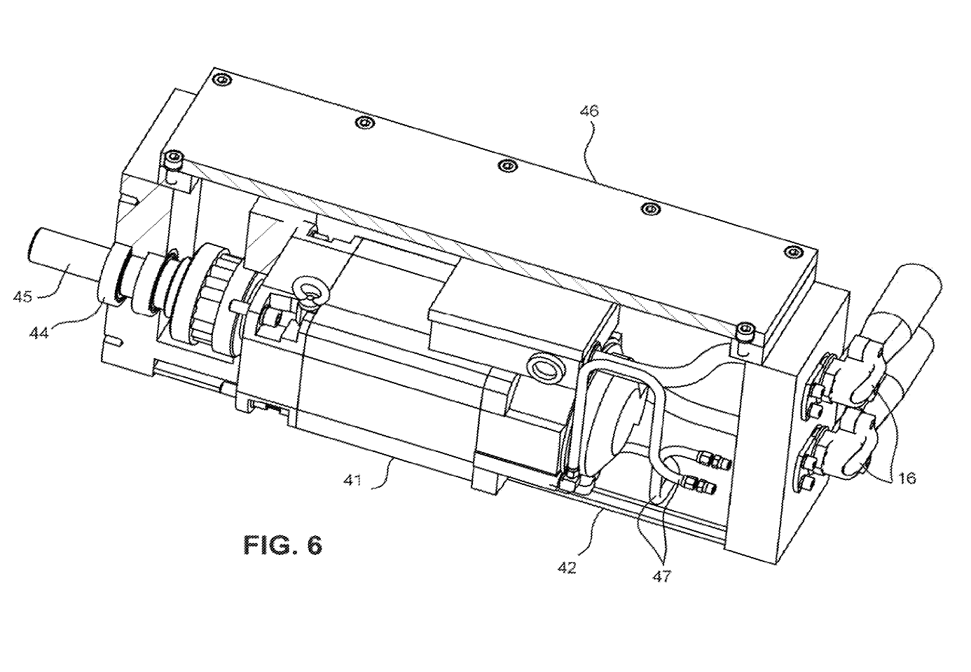

In an alternative construction, with reference to FIG. 6, the electric motor is a liquid cooled electric motor 41 including an output shaft 45 and an output shaft bearing 44. The coolant in the cooling circuit can be circulated through the motor and the enclosure 42 via motor coolant lines 47. Heat from the motor cooling jacket 46 can transfer from the coolant to the enclosure and is dissipated to atmosphere. Additional heat rejection capacity can be provided via an outboard radiator (e.g., radiator 22—see FIG. 1) fitted to the system.

In an alternative arrangement, the prime mover 14 is a standard diesel engine (i.e., non-hazardous rated). The enclosure for the diesel engine may be provided with a removable cover (not shown). The removable cover may also be cooled with the coolant. A suitable coolant may be ethylene glycol, antifreeze, or the like.

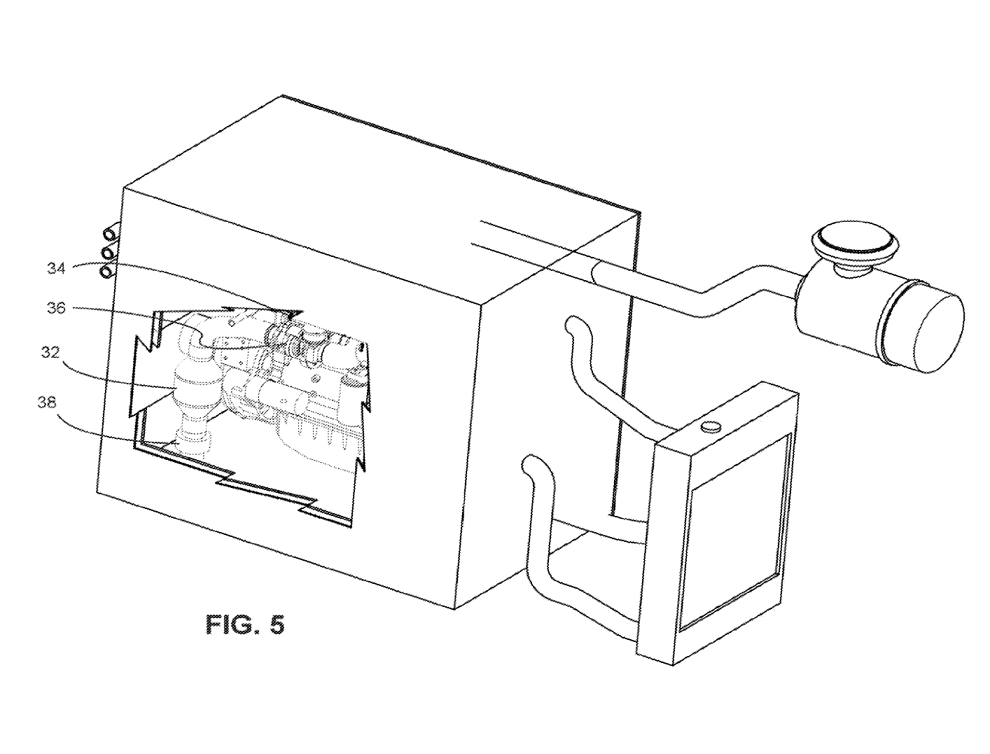

With reference to FIG. 5, the assembly may further include an exhaust circuit and a catalyst 32 as part of an exhaust cooling system 28. The exhaust circuit is configured to route engine exhaust through the catalyst 32 before entering the enclosure. The prime mover assembly may also include an exhaust system with a manifold 34, a turbocharger 36, and the catalyst 32. The exhaust system is insulated from the engine. A spark arrestor 38 may also be provided in the exhaust system. An air circuit supplies air to the engine. The air circuit draws air through an air filter, through the enclosure, through the spark arrestor 38 into the engine. In one arrangement, the floor of the enclosure is provided with tubing 30 between the inner and outer walls of the double wall construction 18, and the coolant is circulated around the tube 30. The coolant may be circulated via a pump through the external radiator 22. This tube transfers the heat from the exhaust gases through the exhaust tube and into the coolant, reducing exiting exhaust gas temperature. A majority of the engine heat can be removed using the engine cooling system. The remaining engine heat will be transferred to the coolant through the interior enclosure wall.

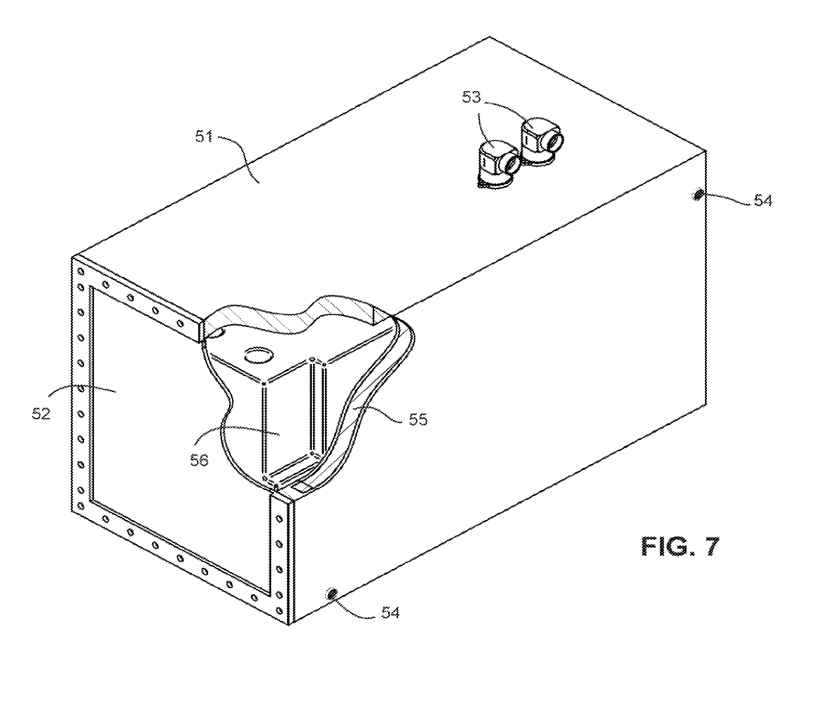

FIG. 7 is a perspective view of an explosion proof capacitor box 51. The box 51 houses a capacitor 56 and includes a double-wall construction with a lid 52. Also included are a cable entry 53 and a coolant port 54. A coolant 55 is provided in the space defined by the double wall construction. The capacitor box allows the use of several different battery chemistries (e.g., lithium chemistries, sodium chemistries, etc.) that have not previously been rated for hazardous environments or otherwise explosion proof. As a result, a non-explosion proof or non-intrinsic safe battery maintenance system (BMS) can be used, which reduces manufacturing costs. Additionally, the capacitor box allows battery charging in the hazardous environment. Typical lead acid batteries can only be charged outside of a hazardous environment. Still further, the construction provides for temperature control of the battery or capacitor and serves to protect the battery or capacitor. Moreover, the box allows the use of non-hazardous capacitors as a source of energy to either assist a main energy source or to be used as an energy source without going through the trouble and expense of manufacturing a hazardous capacitor.

The ability to use non-hazardous rated prime movers and other components in a hazardous environment can result in considerable cost savings. Additional features provide for dissipation of exhaust and heat generated by the prime mover.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A prime mover assembly suitable for use in a hazardous environment, the prime mover assembly comprising:
a hazardous rated enclosure;
a non-hazardous rated prime mover disposed in the enclosure; and
a gland assembly extending through the enclosure in communication with the prime mover, the gland assembly providing power and instrumentation through the enclosure to the prime mover.

2. A prime mover assembly according to claim 1, wherein the enclosure comprises a double wall construction.

3. A prime mover assembly according to claim 2, further comprising a coolant in a space defined by the double wall construction.

4. A prime mover assembly according to claim 1, wherein the enclosure includes an opening through which an output shaft of the prime mover is positioned.

5. A prime mover assembly according to claim 4, wherein the output shaft is supported by a bearing.

6. A prime mover assembly according to claim 1, wherein the prime mover is an electric motor.

7. A prime mover assembly according to claim 6, wherein the electric motor is a liquid cooled electric motor, and wherein the enclosure comprises a double wall construction, the prime mover assembly further comprising a cooling circuit that directs a coolant through the motor and through a space defined by the double wall construction.

8. A prime mover assembly according to claim 7, wherein the cooling circuit further comprises an outboard radiator.

9. A prime mover assembly according to claim 1, wherein the prime mover is a diesel engine.

10. A prime mover assembly according to claim 9, wherein the enclosure comprises a double wall construction and a coolant in a space defined by the double wall construction.

11. A prime mover assembly according to claim 10, further comprising a cooling circuit and a pump that circulates the coolant.

12. A prime mover assembly according to claim 11, wherein the cooling circuit further comprises an outboard radiator.

13. A prime mover assembly according to claim 9, further comprising an exhaust circuit and a catalyst, wherein the exhaust circuit is configured to route engine exhaust through the catalyst before entering the enclosure.

14. A prime mover assembly according to claim 13, further comprising an exhaust system including a manifold, a turbocharger, and the catalyst, the exhaust system being insulated from the engine.

15. A prime mover assembly according to claim 14, further comprising a spark arrestor in the exhaust system.

16. A prime mover assembly according to claim 15, further comprising an air circuit that supplies air to the engine, the air circuit drawing air through an air filter, through the enclosure, through the spark arrestor and to the engine.

17. A prime mover assembly according to claim 1, wherein the prime mover is one of a capacitor and a battery.

18. A prime mover assembly suitable for use in a hazardous environment, the prime mover assembly comprising:
a hazardous rated enclosure including a double wall construction;
a prime mover including one of an electric motor, a diesel engine, a capacitor and a battery;
a gland assembly extending through the enclosure in communication with the prime mover, the gland assembly providing power and instrumentation through the enclosure to the prime mover; and
a coolant in a space defined by the double wall construction.
